(19) United States
(12) Patent Application Publication
(10) Pub. No.: US 2009/0144273 A1
(43) Pub. Date: Jun. 4, 2009

(54) SYSTEM AND METHOD FOR MUSIC AND COMPATIBILITY MATCHING

(76) Inventor: Paul Kappos, Centerville, UT (US)

Correspondence Address: RADER, FISHMAN & GRAUER PLLC, 10653 SOUTH RIVER FRONT PARKWAY, SUITE 150, SOUTH JORDAN, UT, 84095, US

(21) Appl. No.: 12/327,657

(22) Filed: Dec. 3, 2008

Related U.S. Application Data
(60) Provisional application No. 60/991,933, filed on Dec. 3, 2007.

(51) Int. Cl. G06F 7/06; G06F 17/30; G06Q 30/00

(52) U.S. Cl. 707/5; 705/14; 707/E17.108

(57) ABSTRACT

An exemplary system includes a searching and matching subsystem configured to communicate with an access device and a commercial device over a data communication network, the searching and matching subsystem including, a session module configured to assign a session identifier to a session initiated by an access device, the access device being associated with the session, a data store configured to store playlists of said access devices, and a compatibility module configured to identify compatible user playlists when directed by an access device.

### RELATED APPLICATIONS

This application claims the benefit under 35 U.S.C. § 119(e) of U.S. Provisional Patent Application No. 60/991,933 filed Dec. 7, 2007 which is titled “Systems and methods for music matching with a compatibility matching component”. The above-mentioned application is incorporated herein by reference in its entirety.

### TECHNICAL FIELD

The present system and method relates to both music matching and social compatibility matching. More specifically, the present system and method relates to utilizing user playlists to identify additional songs the user might purchase as well as to identify other potential socially compatible users.

### BACKGROUND

The popularity of the Internet has made it a productive communication, transactional, advertising, and social medium. In fact, a large portion of the population uses the internet for obtaining news, communicating with friends and family via chat rooms and instant messaging, and for work.

Similarly, digital personal music devices have become mainstream. Current MP3 players, such as the Apple iPod, the Microsoft Zune, the San Disk Rhapsody, the Toshiba Gigabeat, the Creative Labs Zen Vision, Lexar MP3 player, and similar devices, are play-back-only or storage, playback and share-type devices. The Zune includes provision for wireless sharing, directly to other Zune devices, of sample tracks, playlists, pictures, or “homemade” recordings. Recently, mobile phones have been configured to permit the creation of ring tones, and to permit uploading and downloading for sharing. In addition, many mobile phones provide media playback options equivalent to those of devices designed for exclusively for music playback

Socially, people enjoy interacting with others that have the similar, but not exactly the same tastes and interests. Similarity in interests fosters easy dialogue and enjoyable debate. Through the interaction of similarly minded people, slightly different opinions and interests are shared and enjoyed, thereby expanding the experience of both parties.

### BRIEF DESCRIPTION OF THE DRAWINGS

The accompanying drawings illustrate various embodiments of the principles described herein and are a part of the specification. The illustrated embodiments are merely examples and do not limit the scope of the disclosure. Throughout the drawings, identical reference numbers designate identical or similar elements.

FIG. 1 is a block diagram illustrating an exemplary Internet based communication system, according to principles described herein.

FIG. 2 is a block diagram of an exemplary music searching and matching subsystem of FIG. 1, according to principles described herein.

FIG. 3 is a block diagram of an exemplary compatibility subsystem of FIG. 2, according to principles described herein.

FIG. 4 is a flowchart illustrating an exemplary music based compatibility search process, according to principles described herein.

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape or the relative position of the particular elements, and have been solely selected for ease of recognition in the drawings. Throughout the drawings, identical reference numbers designate similar but not necessarily identical elements.

### DETAILED DESCRIPTION

This specification describes systems and methods for music search based compatibility matching. The systems and methods described herein facilitate the search and matching of users with similar tastes of music. Additionally, the matching of similar tastes of music may be used as a basis for social compatibility matching. The music-based compatibility matching provides a common foundation on which to build social interaction.

Compared with conventional compatibility matching systems, the systems and methods described herein are easier to implement, better for establishing a solid foundation of likes and interests, and generally more productive for music aficionados. Significantly, the systems and methods described herein facilitate both music matching and enable a user to identify music enjoyed by people with similar tastes. Additionally, the purchase of similar music may be facilitated. Furthermore, people with matching music interests may then use the present exemplary system and method to evaluate compatibility for further social interaction. Accordingly, users can confidently use the compatibility and music services knowing that individuals identified as being compatible will at least have similar musical tastes.

In addition, the systems and methods described herein generally provide incentive for users to legally sample and purchase music that is similar to the music that they already own and enjoy. According to one exemplary embodiment of the present exemplary system and method, users are directed to legal pay-per-purchase sites for broadening their music libraries. Thus, to the benefit of music vendors, musical interest correlation can increase the sale and distribution of music by implementing the music based search systems and methods described herein.

Furthermore, according to one embodiment, the systems and methods described herein allows a user to prioritize the importance of various facets of the music-based compatibility matching. By weighting various factors in the music-based compatibility search, the user plays a significant role in determining the method used to find compatible music and/or other socially compatible users.

Traditional systems utilize predetermined parameters for comparing a user's playlist with those of other users to determine compatibility. These traditional systems can be described as utilizing a fixed decision tree algorithm. Accordingly, traditional systems match a user's playlist by comparing it to predefined genre or style play lists, match the playlist with a large selection of compatible songs, and finally present the user with a random sample list of the large selection of compatible songs. In contrast, according to one embodiment of the present system and method, a user weights various factors as being of greater or lesser import. Consequently, the algorithm for determining compatible music in the present system and method can be considered a form of fuzzy logic. That is, the algorithm used to determine compatible songs and/or users is dynamic. Accordingly, a user, by weighting various factors based on importance, modifies the algorithm used to return music-based compatible songs and/or socially compatible users.

These and other uses and benefits of the systems and methods described herein will become apparent upon consideration of the following examples. Specifically, the use of a fuzzy logic system provides users with a custom tailored list of compatible songs and users based on the weight the user gave each considered factor.

### Exemplary System View

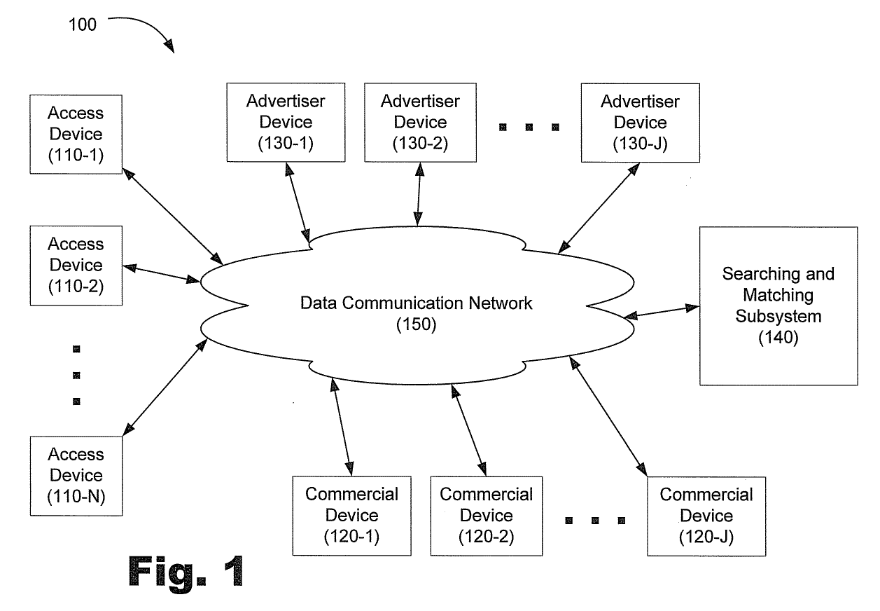

FIG. 1 illustrates an example of a music search compatibility system (100). As shown in FIG. 1, the exemplary music search compatibility system (100) may include access devices (110-1) through (110-N) (collectively “access devices (110)”), commercial devices (120-1) through (120-J) (collectively “commercial devices (120)”), and a searching and matching subsystem (140) communicatively coupled to one another by a data communication network (150). In some examples, a data communication network (150) includes the Internet or World Wide Web. Access devices (110), commercial devices (120), and searching and matching subsystem (140) may communicate over a data communication network (150) using any known communication technologies, devices, media, and protocols supportive of remote communications, including, but not limited to, transmission media, communications devices, Transmission Control Protocol (“TCP”), Internet Protocol (“IP”), File Transfer Protocol (“FTP”), telnet, Hypertext Transfer Protocol (“HTTP”), socket connections, packet-switching technologies, circuit-switching technologies, wireless communication technologies (e.g., cellular telephone and wireless access technologies), WiMax, and any other suitable communications technologies.

Users of system (100) may be grouped into different categories having different levels of access to different functions provided by system (100). Users associated with access devices (110) may be referred to as “consumers,” users associated with commercial devices (120) may be referred to as “vendors,” and users associated with searching and matching subsystem (140) may be referred to as “providers.”

Through access devices (110), consumers are able to interact with the searching and matching subsystem (140), other consumers, and commercial devices (120), including accessing, considering, sampling, and purchasing content hosted by the commercial devices (120), providing input to, receiving output from, and participating in sessions between access devices (110) and the searching and matching subsystem (140). Because consumers may not be aware of commercial devices (120) or how to access commercial devices (120), the searching and matching subsystem (140) will facilitate communication between the access devices (110) and the commercial device (120), as will be described in detail below.

The content provided by the searching and matching subsystem (140) and/or the commercial devices (120) may be published on a site hosted by the searching and matching subsystem (140) or one or more sites hosted by commercial devices (120). Accordingly, consumers can use access devices (110) to interact with commercial devices (120) and searching and matching subsystem (140) over a data communication network (150) to view content, including published advertisements associated with various advertisers (130). When consumers select published advertisements (e.g., by clicking on a hyperlink of an advertisement), commercial devices (120) and/or the searching and matching subsystem (140) may direct the access devices (110) used by the consumers to sites hosted by advertiser devices (130).

While an exemplary system (100) is shown in FIG. 1, those skilled in the art will recognize that the exemplary components illustrated in the illustration are not intended to be limiting. Indeed, those skilled in the art will recognize that other alternative hardware environments and implementations may be used. Each of the components of system (100) will now be described in additional detail.

A. Data Communication Network

A data communication network (150) may include one or more networks suitable for carrying communications between access devices (110), commercial devices (120), advertiser devices (130), and searching and matching subsystem (140). For example, a data communication network (150) may include, but is not limited to, the Internet, World Wide Web and/or one or more intranets, local area networks, wide area networks, voice communication networks (e.g., the Public Switched Telephone Network (“PSTN”), Voice over Internet Protocol (“VoIP”), and wireless telephone networks), video and/or audio broadcasting networks (e.g., satellite and cable television networks), access networks, packet-switched networks, circuit-switched networks, and any other communications networks capable of carrying communications between access devices (110), commercial devices (120), advertiser devices (130), and/or searching and matching subsystem (140). Data communication network (150) may include any devices, media, and technologies helpful for carrying communications between access devices (110), commercial devices (120), advertiser devices (130), and searching and matching subsystem (140).

B. Access Devices

Each access device (110) may include any device or devices physically or remotely accessible to one or more consumers and that allows a consumer to provide input to and/or receive output from commercial devices (120), advertiser devices (130), and/or searching and matching subsystem (140) over a data communication network (150). For example, access device (110) can include, but is not limited to, one or more desktop computers, laptop computers, tablet computers, personal computers, personal data/digital assistants, cellular or mobile telephones, satellite pagers, wireless internet devices, embedded computers, video phones, network interface cards, modems, optical network terminals, mainframe computers, mini-computers, programmable logic devices, vehicles, entertainment devices, gaming devices, music devices, wireless communication devices, wireline communication devices, Internet Protocol (“IP”) devices (e.g., IP-based phones), Session Initiation Protocol (“SIP”) devices (e.g., SIP phones), set-top boxes, televisions, display devices, and any other devices capable of communicating with commercial devices (120), advertiser devices (130), and/or searching and matching subsystem 140 over data communication network (150). Access device (110) can also include various peripherals such as a terminal, keyboard, keypad, mouse, screen, printer, stylus, microphone, audio speaker, input device, output device, or any other apparatus that facilitates interaction with an access device (110).

Access devices (110) may be configured to access sites (e.g., web sites) hosted by commercial devices (120), advertiser devices (130), and/or searching and matching subsystem (140). In particular, access devices (110) can participate in sessions with sites hosted by searching and matching subsystem (140) and/or any of the commercial devices (120) to simply receive and present content for consideration by consumers, or to submit requests for specific content, including requests in the form of music search queries (e.g., keyword music searches) and/or music list correlation results. In response, consumers may receive content for consideration through the access devices (110). The content typically includes search results and correlation results, music lists, advertisements associated with advertisers, music sampling interfaces, and/or music purchase interfaces. Accordingly, consumers can select presented content to be directed to additional information.

Access devices (110) may include instructions for generating and operating user interfaces. These instructions may be in any computer-readable format, including software, firmware, microcode, and the like. When executed by a processor (not shown) of a particular access device (110), the instructions may present one or more user interfaces to a user. The user interfaces may be configured to present information to and receive input from consumers, including information associated with search results, music lists, compatibility criteria, music list match criteria, advertisements, selections of advertisements, and sessions with sites hosted by commercial devices (120), advertiser devices (130), and/or searching and matching subsystem (140). The user interfaces may comprise one or more graphical user interfaces (“GUI”) capable of displaying information and receiving input from users. In certain embodiments, the user interfaces include one or more web browsers, such as Internet Explorer® offered by Microsoft Corporation of Redmond, Wash.

Access devices (110) may be configured to utilize any suitable access technologies to access data communication network (150), including, but not limited to, known access networks, media, and protocols.

C. Advertiser Devices

Advertiser devices (130) may be configured to communicate with any of the access devices (110), commercial devices (120), and/or searching and matching subsystem (140) of system (100) over a data communication network (150). Each advertiser device (130) may include one or more devices configured to communicate over data communication network (150), including, but not limited to, hosting one or more sites, communicating with searching and matching subsystem (140) (e.g., providing bids and/or feedback to searching and matching subsystem (140)). For example, advertiser device (130) can include, but is not limited to, one or more servers (e.g., web servers), computers, network access devices, and any other devices capable of communicating with access devices (110), commercial devices (120), and/or searching and matching subsystem (140) over data communication network (150).

Advertisers may use advertiser devices (130) to host sites (e.g., web sites) providing content associated with the advertisers. Access devices (110) can access the sites hosted by advertiser devices (130). Accordingly, sessions can be conducted between access devices (110) and advertiser devices (130). The sessions allow consumers to interact with the sites hosted by advertiser devices (130) to produce different results.

A session between an access device (110) and an advertiser device (130) may allow a consumer to perform a variety of actions, including, but not limited to, considering content hosted by the advertiser device (130), researching services or products, providing information (e.g., contact and payment information) to advertiser device (130), making a purchase, completing a registration, application, or survey, providing a consumer review of a product or service, placing an order, completing a sale, providing a referral, submitting a question or an answer to a question, and any other interaction between the consumer and the advertiser device (130). Any of the above-listed actions may be predefined as an event or events that add value to the advertiser. In certain embodiments, a predefined event includes completion of a sale during a session.

Advertiser devices (130) may be configured to provide feedback to searching and matching subsystem (140) for each session. The feedback may indicate whether one or more predefined events occurred during a session (i.e., whether the session resulted in value being added to the advertiser, resulting in compensation being owed to searching and matching subsystem (140)). For example, a predefined session event may include a sale being made to a consumer. When a particular session results in a sale, the corresponding advertiser device (130) may provide positive feedback to searching and matching subsystem 140. In certain embodiments, positive feedback is provided in the form of a binary “1,” and negative or no feedback is provided in the form of a binary “0.” Of course, other predefined events may be used to determine whether to provide positive or negative feedback to searching and matching subsystem (140).

D. Commercial Devices

Commercial devices (120) may be configured to host sites that may include music sampling services and/or digital music purchasing services. Additionally, the commercial devices (120) may include search tools, or links to search tools, capable of providing further information about musical selections and options, as will be understood by those skilled in the art.

Additionally, Commercial devices (120) may host sites that provide opportunities for users to socially interact. The commercial device may offer users chat, video, audio, messaging services that enable users to socially interact. The commercial device (120) utilizing a searching and matching subsystem (140), via a data communication network (150), allows users to find potential socially compatible users based on music tastes.

Consumers may use access devices (110) to access the sites hosted by commercial devices (120) over a data communication network (150). Accordingly, consumers are able to access music resources and/or search tools provided by searching and matching subsystem (140) through commercial devices (120). When a particular consumer uses an access device (110) to select a song or album in a site hosted by a commercial device (120), the access device (110) may be directed, via the searching and matching subsystem (140) to the commercial device (120).

E. Searching and Matching Subsystem

The searching and matching subsystem (140) may include any device or combination of devices (e.g., servers) useful for communicating with access devices (110), commercial devices (120), and advertiser devices (130) over a data communication network (150). Searching and matching subsystem (140) may be configured to include and/or utilize any suitable network access technologies, including, but not limited to, servers (e.g., web servers), security technologies, access levels, predefined access rules, firewalls, user lists, sign-on technologies, content hosting technologies, and any other technologies for communicating with access devices (110), commercial devices (120), and advertiser devices (130) over a data communication network (150).

In certain embodiments, searching and matching subsystem (140) is implemented in one or more computers. Searching and matching subsystem (140) may include any computer hardware and/or instructions (e.g., software programs), or combinations of software and hardware, configured to perform the processes described herein. In particular, it should be understood that searching and matching subsystem (140) may be implemented on one physical computing device or may be implemented on more than one physical computing device. Accordingly, searching and matching subsystem (140) may include any one of a number of computing devices known to those skilled in the art (e.g., one or more servers), and may employ any of a number of computer operating systems known to those skilled in the art, including, but by no means limited to, known versions and/or varieties of the Microsoft Windows® operating systems, the Unix-based operating systems, the Linux-based operating systems, and/or Macintosh operating systems.

Accordingly, those skilled in the art will recognize that the processes described herein may be implemented at least in part as instructions executable by one or more computing devices. In general, a processor (e.g., a microprocessor) receives instructions, e.g., from a memory, a computer-readable medium, etc., and executes those instructions, thereby performing one or more processes, including one or more of the processes described herein. Such instructions may be stored and transmitted using a variety of known computer-readable media.

A computer-readable medium (also referred to as a processor-readable medium) includes any medium that participates in providing data (e.g., instructions) that may be read by a computer (e.g., by a processor of a computer). Additionally, a computer-readable medium may also transform or otherwise manipulate data. Such a medium may take many forms, including, but not limited to, non-volatile media, volatile media, and transmission media. Non-volatile media may include, for example, optical or magnetic disks, flash-based memory, and other persistent memory. Volatile media may include, for example, dynamic random access memory (“DRAM”), which typically constitutes a main memory. Transmission media may include, for example, coaxial cables, copper wire and fiber optics, including the wires that comprise a system bus coupled to a processor of a computer. Transmission media may include or convey acoustic waves, optical transmissions, and electromagnetic emissions, including those generated during radio frequency (“RF”) and infrared (“IR”) data communications. Common forms of computer-readable media include, for example, a floppy disk, a flexible disk, hard disk, magnetic tape, flash memory, any other magnetic medium, a CD-ROM, DVD, Blu-ray, any other optical medium, punch cards, paper tape, any other physical medium with patterns of physical variance, a RAM, a PROM, an EPROM, a FLASH-EEPROM, any other memory chip or cartridge, or any other medium from which a computer can read.

A searching and matching subsystem (140) may receive a variety of information from access devices (110), commercial devices (120), and advertiser devices (130). For example, searching and matching subsystem (140) may receive data representative of user registration and/or logon information, play lists associated with a user or a user's music device, information associated with or descriptive of requests (e.g., search queries), music correlation criteria, social compatibility criteria, political information, geographical location, feedback provided by advertisers, and advertisement selections. Specifically, searching and matching subsystem (140) may also receive information from the user regarding the importance of various factors in determining compatible playlists or people. That is, a user may weight each of the criteria used by the searching and matching subsystem (140) as having greater or lesser importance. The searching and matching subsystem (140) will return results based on the weight factors assigned by the user.

Searching and matching subsystem (140) may also make a variety of information available to access devices (110), commercial devices (120) and advertiser devices (130). For example, searching and matching subsystem (140) may provide data representative of user registration and/or logon information, information associated with musical tastes and searches, published content (e.g., search results including advertisements), and session identifiers.

According to one exemplary embodiment, searching and matching subsystem (140) returns a list of one or more potentially compatible songs and/or other users. In searching and returning the list of potentially compatible songs, searching and matching subsystem (140) may utilize a wide variety of factors in determining what songs are compatible. According to one exemplary embodiment, factors include the types and qualities of the melodies, harmonies, rhythms, forms, compositions, and lyrics.

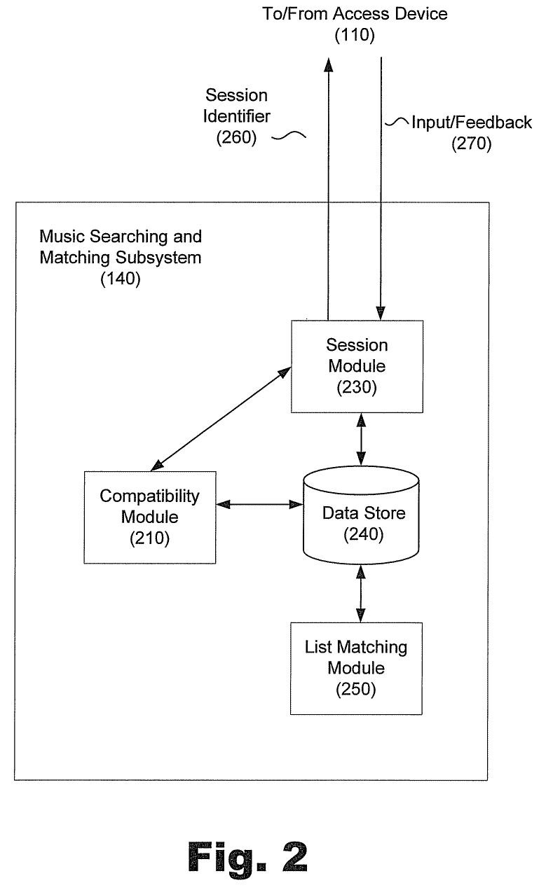

FIG. 2 is a block diagram illustrating exemplary components of searching and matching subsystem (140), according to one exemplary embodiment. As shown in FIG. 2, searching and matching subsystem (140) may include compatibility module (210), session module (230), data store (240), and list-matching module (250) communicatively coupled to one another as shown. Session module (230) may be configured to provide a session identifier (260) to a particular user or access device (110) and to receive input data and feedback (270) from the access device (110) and/or an advertiser device (130). Elements and functions of the exemplary searching and matching subsystem (140, FIG. 2) are described in detail below.

### Session Module

Session module (230) may be configured to recognize consumers requesting music searches and compatibility searches, selecting (e.g., clicking on) advertisements, and/or sampling and purchasing musical selections. For example, session module (230) may be configured to detect, over a data communication network (150), when a previously registered, or newly registered consumer using an access device (110) contacts the searching and matching subsystem (140) to request an operation.

Upon detecting a selection or request by a consumer via an access device (110), session module (230) may initiate a session between the access device (110) (e.g., access device 110-1) and the music searching and matching subsystem (140) that is associated with the selection or request. To initiate the session, session module (230) may direct the access device (110) to the compatibility module and/or to the list-matching module, as will be understood by those skilled in the art. Such a system may include asymmetric cryptography or secret key cryptography, where public and private keys are provided on an initial registration by the access device (110) with the session module (230).

As part of initiating the session, session module (230) may be configured to provide session identifier (260) to the access device (110). The session identifier (260) may be in any form and include any information suitable for identifying the session, such as a numeric or alphanumeric code, for example. The session identifier (260) may be used in place of other types of information so as to provide quick and efficient recall of the session information if desired. This may be helpful for protecting system (100) from manipulation. For example, the use of unique session identifiers (e.g., session identifier (260)) protects consumer identity and can make it difficult for hackers to access user information because persons accessing the system are not provided with information related to the sources of sessions.

Session module (230) may be configured to perform additional operations to limit the information made available to advertiser devices (130). For example, session module (230) may be configured to mask the Internet Protocol (“IP”) addresses associated with the access device (110) and/or searching and matching subsystem (140). Masking of IP addresses will be understood by those skilled in the art. Searching and matching subsystem (140) may be configured to provide additional information (e.g., IP addresses and/or information about sources of results) to advertiser devices (130), access devices (110), or commercial devices (120), if authorized by the consumer.

Sessions initiated by session module (230), as well as the session identifiers associated with the sessions may be recorded and stored to data store (240). Sessions may be conducted between access devices (110) and advertiser devices (130), commercial devices (120), and/or the searching and matching subsystem (140) in any of the ways described above and may include occurrences of one or more predefined session events, such as any of the exemplary session events listed above. As previously described, advertiser devices (130) may be configured to provide feedback (e.g., feedback (270)) to searching and matching subsystem (140) based on the occurrences or lack of occurrences of predefined events during the session.

Accordingly, session module (230) may be configured to receive feedback (270) from the advertiser device (130). Session module (230) is able to associate feedback (270) with a corresponding session identifier (260). The feedback (270) may be stored in data store (240), along with the session identifier (260) associated with the feedback (270). The feedback (270) may include any of the data described above, including data representative of whether a predefined event occurred during the session.

### Data Store

Data store (240) may include one or more data storage mediums, devices, or configurations and may employ any type, form, and combination of storage media known to those skilled in the art, including hard disk drives, read-only memory, caches, databases, optical media, solid-state drives, NAND flash non-volatile memory, multi- and single-level cell flash memory, and random access memory. Data store (240) may include any known technologies useful for storing, updating, modifying, accessing, retrieving, and deleting data.

Data store (240) may include any suitable type or form of electronic data representative of or associated with session feedback, session identifiers, user access privileges, bids received from advertisers, advertisements, information associated with advertisers, commercials, and consumers, information associated with access devices (110), commercial devices (120), and advertiser devices (130), and any other information that may be potentially useful for allocating advertising revenues based on session feedback. The data may be stored in extensible markup language (“XML”), or in any suitable form.

While FIG. 2 illustrates data store (240) as being included in searching and matching subsystem (140), this is not limiting. For example, searching and matching subsystem (140) may be configured to store and/or retrieve data to/from external data sources. Any data potentially helpful for collecting session feedback and allocating advertising revenues based on the feedback may be retrieved from any suitable and accessible internal or external data source.

Feedback, play lists, compatibility characteristics, user profiles, and session identifiers stored in data store (240) can be used to respond to compatibility and/or play list-matching requests. The data may be organized per consumer, access device (110), play list, or other suitable criteria. Alternatively, all or a portion of the data described above as being stored on data store (240) may be stored on access device (110). Accordingly, as data is needed or desired, the data may be accessed via a data communication network (150). The control of important or required data may be stored on data store (240) connected to searching and matching subsystem (140), while data deemed less important, or only important to the user, may be stored on the access device (110). Consequently, when the access device (110) interacts with searching and matching subsystem (140) via a data communication network (150), all of the necessary information and data for searching and determining potentially compatible songs and users is located on access device (110).

### List-Matching Module

List-matching module (250) may be configured to receive, analyze, and correlate play lists with stored user play lists and other criteria contained in the data store (240) or on other access devices (110) connected via a data communication network (150). The correlation and percentage of play list match may be determined according to a number of criteria. For example, according to one exemplary embodiment, a play list may be matched to available play lists stored in the data store (240) according to any number of matching criteria including, but in no way limited to, a direct list match, a percentage of direct list match, a ratio of songs matched, and the like. For example, if a particular user is seeking to encounter music that is similar to their own tastes and interests, they may want to consider play lists compiled by users with similar songs. Logically, users with similar songs, will be able to introduce the searching user to additional songs of the same or similar genre. Consequently, the user will be able to broaden their horizons musically.

Alternatively, list-matching module (250) may utilize wide variety of factors in determining potentially compatible songs including, but in no way limited to, the types and qualities of the melodies, harmonies, rhythms, forms, compositions, and lyrics. Furthermore, according to one embodiment, a user prioritizes the importance of various factors used to determine compatible songs. By weighting various factors in the music-based compatibility search, the user plays a significant role in determining the method used to find compatible music and/or other socially compatible users.

Traditional systems utilize a fixed decision tree algorithm. Accordingly, traditional systems match a user's playlist by comparing it to others users' playlists, match the playlist with a large selection of compatible songs, and finally present the user with a random sample list of the large selection of compatible songs. Alternatively, traditional systems match a user playlist or song selection by comparing musical attributes of the selected song and a collection of other songs. Each of these traditional systems to not account for user preferences and tastes in determining compatibility. Consequently, traditional systems fail to account for the varying tastes of each consumer.

In contrast, according to one embodiment of the present system and method, a user weights various factors as being of greater or lesser import. Consequently, the algorithm for determining compatible music in the present system and method can be considered a form of fuzzy logic. The algorithm used to determine compatible songs and/or users is dynamic. Accordingly, a user, by weighting various factors based on importance, modifies the algorithm used to return music-based compatible songs and/or socially compatible users. For example, a user may specify what percentage of their playlist they want to match with the playlists of others, or, similarly, what percentage of another's playlist is the same as their own playlists. Likewise, the user may specify the importance of geography, political information, religious affiliation, physical features, age, harmony, rhythm, lyrics, ratings, genres, length of song, year songs were made, and any other information that might be used to match and find potentially compatible songs. Furthermore, the user may elect to exclude factors from the algorithm used to find matching songs. Consequently, in the present system and method, the unique tastes of each user are accounted for by allowing the user to weight the importance of the factors used to determine compatible songs and/or users.

Furthermore, a user may weight the factors differently for the searching of songs than for the searching of compatible users. A user may not have a geographical preference for matching songs. However, in determining matching users, the user may place a high importance on a specific geographical location. Any number of the weighted factors may apply to only the search for compatible users. Likewise, a number of the weighted factors may exclusively apply to the search for compatible songs.

Once the list-matching module has performed its operation, the results may be displayed to the user in a number of ways including, but in no way limited to, displaying a list of the most compatible users, a list of the corresponding play lists, and the like. The list may be searchable and ordered in any number of useful ways. Specifically, the list may be reordered based on any of the previously mentioned weighted factors. For example, a user may elect to order the matched songs by the year produced, by the title, by the likelihood of compatibility, or any other factor initially used to determine compatibility. Similarly, the list of compatible users may be ordered and reordered by the user in a number of ways including, but not limited to, geography, age, physical attributes, sex, and other factors initially used to determine compatibility.

### Compatibility Module

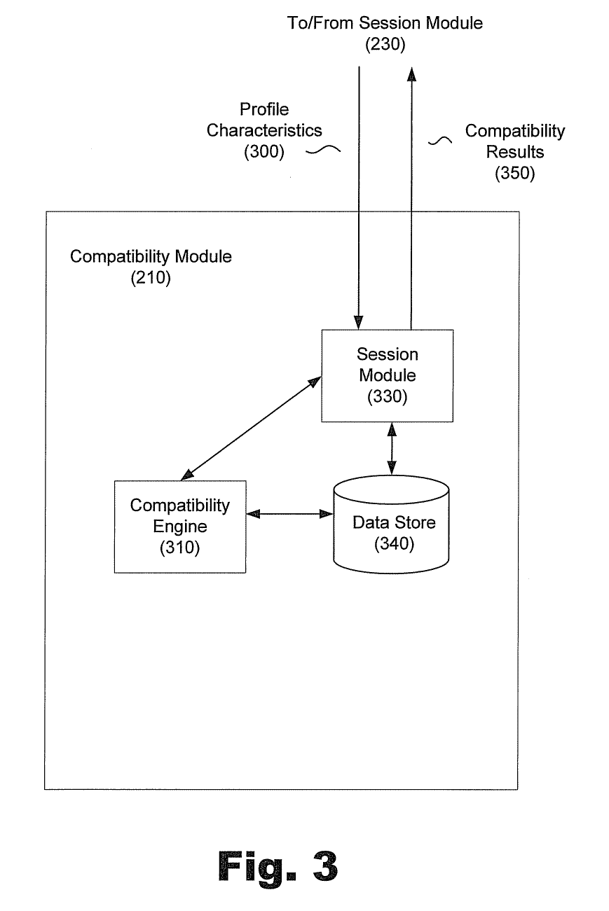

According to one exemplary embodiment, as illustrated in FIG. 3, a compatibility module (210) may form an integral part of the present exemplary system and method. As mentioned previously, people with similar musical tastes may also share many other interests. Consequently, the present exemplary system and method may be used to provide compatibility matching services to users. According to one exemplary embodiment, a user who is interested in being matched using the compatibility module (210) will provide profile characteristics (300) when the user is logged onto the system for the first time or, alternatively, when the user indicates that they would like to utilize the compatibility module. According to one exemplary embodiment, the profile characteristics (300) may include any number of personal characteristics including, but in no way limited to, religious affiliation, artistic interests, musical interests, sexual preferences, geographical information, professional profile information, and the like. As described above, the use may assign more weight to some characteristics than others. By weighting the importance of each of the factors used to determine compatibility, users are presented with a more personalized list of potentially compatible users.

When a user provides the profile characteristics (300), they are associated with a session module (330) to facilitate the repeatability and to facilitate efficient searching for compatibility results in future sessions. Additionally, as illustrated in FIG. 3, the profile characteristics (300) may be saved in a data store (340) associated specifically with the compatibility module (210) or they may be saved on the access device (110) for use each time the user accesses the compatibility module. As was mentioned previously, the data store (340) may be physically associated with the compatibility module, or alternatively, it may be located elsewhere with data management services associated with the data store (340) provided to the compatibility module (210) remotely, including the access devices (110) themselves.

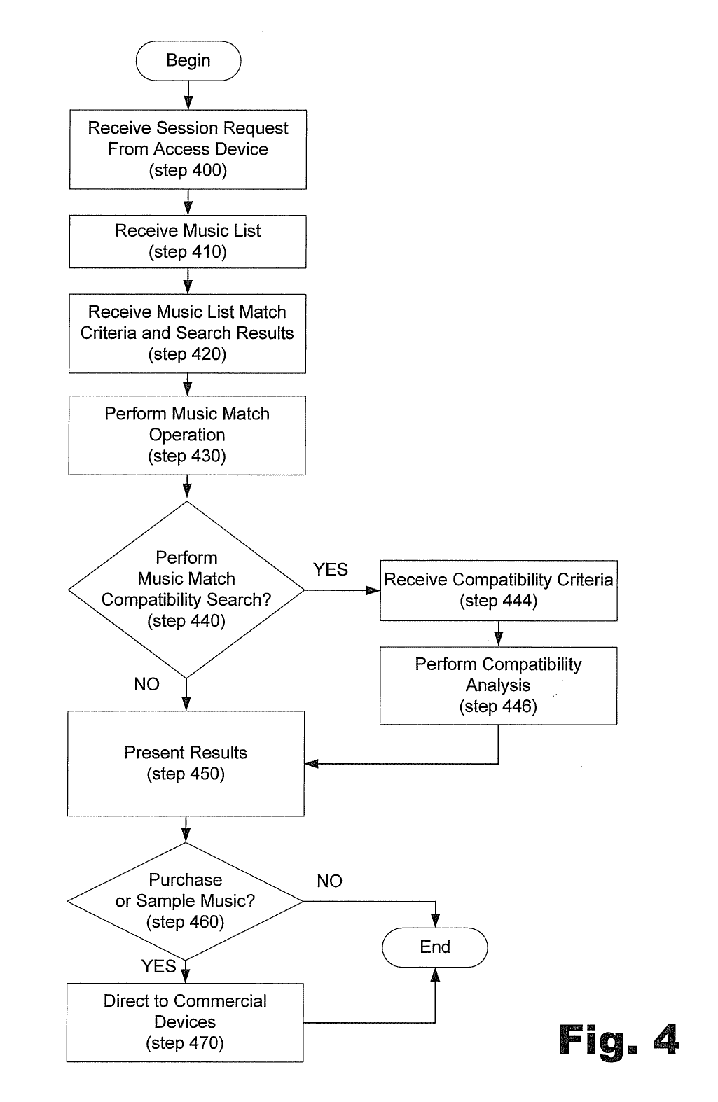

According to the present exemplary system and method, the compatibility module (210) includes a compatibility engine (310) configured to perform compatibility analyses for a requesting user. For example, according to the present exemplary embodiment, when a user desires to use the compatibility module (210), the main criterion for compatibility matching is play list correlation, as mentioned previously. Particularly, it is believed that compatibility between music tastes is a strong indicator of complementary interests and personalities. Additionally, other profile characteristics (300) and preferences may be considered when providing compatibility results (350) to a user, according to one exemplary embodiment. Additionally, the factors described above in reference to the list-matching module. Further details of the present exemplary system and method will be provided below with reference to FIG. 4.

### Exemplary Process View

FIG. 4 illustrates an exemplary music matching and compatibility matching process, according to one exemplary embodiment. While FIG. 4 illustrates exemplary steps according to one embodiment, other embodiments may omit, add to, reorder, and/or modify any of the described steps.

As illustrated in FIG. 4, the session begins by first receiving a session request from an access device (step 400). As previously mentioned, the session request may be initiated by a user accessing the present exemplary system (100) for the first time, or alternatively, may be a return user. Any number of security methods may be implemented including methods utilizing public and private keys. Once the session request is received by the present exemplary system, a music list is received from the access device (110, step 410). According to one exemplary embodiment, a user is able to load a specific music list, a previously identified portion of a music list to the present system, or even single song. According to one exemplary embodiment, the music list, or portion of a music list provided to the present exemplary system may be sent directly from a user's access device (110). The submission of the playlist may include any number of associated information that may be useful in determining compatible songs and users including, song name, total time of songs, artists, albums, genres, personal user ratings of each song, number of times each song has been played. Additionally, when a user submits a playlist for consideration, the searching and matching subsystem (140) may also receive a list of all the songs on the user's access device (110). Knowing all the songs on the access device (110) will allow the searching matching subsystem to return only songs the user does not currently own. This will significantly improve the chances the user will purchase the songs found to be compatible.

Once the music list is provided to the present exemplary system, the music list match criteria and desired search result format is provided to the present system and method (step 420). As mentioned previously, the music list match criteria may be any number of matching schema including, but in no way limited to, percentage of songs matched, ratio of songs matched with the desired list, and the like. Additionally as described above, the user may weight each of the criteria and factors used to determine compatibility. Additionally, the search results criteria may be embodied in any number of display methods including, but in no way limited to, lists of matching play lists, lists of matching users, characteristics of matching users, graphical illustrations of albums found on matching play lists, and the like. Additionally, the matching play lists may be provided in order of relevance, as determined by the music list match criteria, or in order of relevance as specified by the user. The algorithm used to determine matching and compatible songs and users is referred to as a fuzzy logic algorithm in that it allows the user to dynamically modify the method used by weighting each of the factors used to determine compatibility.

Once the music list match criteria and search results preferences are provided (step 420), a music match operation may be performed by the present exemplary system and method (step 430). Particularly, as previously described, any number of data stores (240, 340) may be accessed to perform the music match operation (step 430).

After the music match operation is performed (step 430), the user may be prompted to perform a music match compatibility search (step 440). If a music match compatibility search is requested by the user (YES, step 440), the system receives the compatibility criteria provided by the user (step 444), and performs a compatibility analysis (step 446), using the previously performed music match operation (step 430) as an initial correlation tool when determining compatibility. However, as mentioned previously, other compatibility criteria may be identified and factored when performing compatibility analysis (step 446) including the weighted factors specified by the user.

Once the compatibility analysis (step 446) is performed, if requested, the results of the music match operation (step 430) and, if requested, the compatibility analysis (step 446) may be presented to the users (step 450) for their use. As previously described, the various search results may be provided to the user (step 450) in any number of formats including, but in no way limited to, text only lists, playlists that may be cut and pasted into future playlists, graphical representations of users and/or playlists, etc.

When the playlists search results are provided to the user, the user may be prompted to purchase or sample the music provided in the search results (step 450). According to one exemplary embodiment, the option to purchase and/or sample music is provided to the user through the data communication network (150) via the searching and matching subsystem (140) directing a user to a commercial device (120, step 470). According to one exemplary embodiment, the direction by the searching and matching subsystem (140) to the commercial devices (step 470) may be performed by any number of framing, forwarding, and/or other re-direction mechanisms configured to attribute the reference of a potential customer to the searching and matching subsystem.

Once the desired music is purchased and/or sampled (step 470) or the opportunity to do so is denied by the user (NO, step 460), the exemplary session is terminated. As will be understood, any number of alternative steps may be performed by the exemplary system and method including, but in no way limited to, facilitating chat rooms for users matched by the compatibility analysis (step 446), facilitating matching or communities of users with compatible playlists, identifying and matching potential customers with advertisers based on the user's playlists and/or user profiles, etc.

### ALTERNATIVE EMBODIMENTS

The preceding description has been presented only to illustrate and describe embodiments of the principles described herein. It is not intended to be exhaustive or to limit the disclosure to any precise form disclosed. The principles described herein may be practiced otherwise than is specifically explained and illustrated without departing from their spirit or scope. For example, the principles described herein may be implemented in a wide variety of electronic marketing applications, including, but not limited to, online search advertising, paid online search advertising, paid advertising, advertising associated with Internet Protocol based (“IP-based”) video applications (e.g., IP television), compatibility matching using religion, politics, art interests, etc. It is intended that the scope of the present exemplary system and method be defined by the following claims.

What is claimed is:

1. A system comprising:
a searching and matching subsystem;
at least two access devices;
wherein said searching matching subsystem configured to communicate with said at least two access devices; and
wherein said searching and matching subsystem is configured to receive a user playlist from a first access device, receive a plurality of weighted factors to be used in finding a number of compatible playlists on said at least two access devices, compare said user playlist to a number of possible compatible playlists using said plurality of weighted factors, identify compatible user playlists on said access devices based on said plurality of weighted factors, and return data associated with said identified compatible user playlists to said first access device.

2. The system of claim 1, further comprising a compatibility module configured to identify potential socially compatible users based on said identification of compatible user playlists.

3. The system of claim 2, further comprising a session module configured to assign a session identifier to a session initiated by said access devices, the access device being associated with the session.

4. The system of claim 2, wherein said compatibility module is configured to identify said compatible user playlists according to one of a percentage of matching songs or ratio of matching songs.

5. The system of claim 4, wherein said first access device assigns a weight to each of said plurality of weighted factors used by the compatibility module in determining compatible user playlists, thereby creating a fuzzy logic algorithm for determining compatibility.

6. The system of claim 2, wherein said identified compatible user playlists are transmitted to said first access device for graphical display.

7. The system of claim 2, wherein said compatibility module is configured to receive compatibility criteria from said access devices, said compatibility criteria being configured to aid in the identification of potentially socially compatible users.

8. The system of claim 6, wherein said system further comprises at least one commercial device;
wherein said searching and matching subsystem is communicatively connected to said at least one commercial device;
wherein, based on said user play list, said searching and matching subsystem provides said access devices related songs available for purchase via said at least one commercial device.

9. The system of claim 8, wherein said system further comprises at least one advertiser device;
wherein said searching and matching subsystem is communicatively connected to said at least one advertiser device; and
wherein said searching and matching subsystem provides advertisements to said access devices, via said at least one advertiser device.

10. A system comprising:
a searching and matching subsystem;
at least two access devices;
a compatibility module;
wherein said searching and matching subsystem further comprises a session module assigning a session identifier to a session initiated by one of said access devices, the access device being associated with the session.
wherein said searching and matching subsystem is configured to identify compatible user playlists on said access devices; and
wherein said compatibility module is configured to identify potential socially compatible users based on said identification of compatible user playlists.

11. The system of claim 10, wherein said compatibility module is configured to identify said compatible user playlists according to one of percentage of matching songs or ratio of matching songs.

12. The system of claim 11, wherein said compatibility module accepts input from said access devices specifying the weight of each of the factors used in the algorithm used to determine compatible songs.

13. The system of claim 12, wherein said compatibility module is configured to receive compatibility criteria from said access devices, said compatibility criteria being configured to direct said identification of potentially socially compatible users.

14. The system of claim 13, further comprising at least one commercial device;
wherein said searching and matching subsystem is communicatively connected to said at least one commercial device;
wherein, based on said user playlist of said access device, said searching and matching subsystem provides said access devices related songs available for purchase via said at least one commercial device.

15. The system of claim 14, wherein when said access devices elects to purchase said related songs, said access device is directed to said commercial device, where users are able to download said related songs directly to said access devices.

16. The system of claim 15, further comprising at least one advertiser device; wherein, said access devices are shown advertisements; and wherein when said access device selects an advertisement, said access device is directed to said advertiser device.

17. The system of claim 15, wherein said access devices receive said a list of one or more of said potentially socially compatible users; and are provided at least one song available for purchase, via said at least one commercial device, on the playlists of one or more of said potentially socially compatible users.

18. A method for finding potential socially compatible users comprising:
a searching and matching subsystem;
at least two access devices;
a compatibility module;
wherein said searching and matching subsystem is configured to identify compatible user playlists on said access devices;
wherein said compatibility module is configured to identify potential socially compatible users based on said identification of compatible user playlists; and
wherein said access devices weight the factors used by at least one of said searching and matching subsystem and said compatibility module to identify said compatible user playlists and said potential socially compatible users

19. The method of claim 18, wherein said compatibility module is configured to receive compatibility criteria from said access devices, said compatibility criteria being configured to direct said identification of potentially socially compatible users.

20. The method of claim 19, wherein said access devices are provided a list of at least one potential socially compatible user based on said user playlist as well as options to purchase songs related to the playlists of said potential socially compatible users.
